(19) United States
(12) Patent Application Publication
(10) Pub. No.: US 2007/0198554 A1
(43) Pub. Date: Aug. 23, 2007

(54) Apparatus for business service oriented management infrastructure

(75) Inventor: Lei Liu, San Jose, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/351,686

(22) Filed: Feb. 10, 2006

(51) Int. Cl. G06F 7/00

(52) U.S. Cl. 707/101

(57) ABSTRACT

A method for management of a grid fabric that includes receiving a management request using a protocol, decoupling the management request from the protocol to obtain a decoupled management request, selecting a grid control service from a plurality of grid control services configured to perform the decoupled management request, identifying at least one node in the grid fabric associated with the decoupled management request by the grid control service, executing at least one command based on the decoupled management request using the at least one node and the grid control service, wherein the at least one command generates a result, and outputting the result.

### BACKGROUND

Large organizations typically include a data center for distributing data to both inside and outside the organization. The data center often includes a grid fabric. A grid fabric includes a group of nodes (e.g., web servers, database servers, farm servers, etc.) and the connection (e.g., wires, circuit boards, wireless signals, etc.) between the nodes. The nodes within the grid fabric are typically heterogeneous with respect to both hardware and software. For example, certain nodes may use different operating system from other nodes in the grid fabric.

Each node in the grid fabric provides functionality to nodes in the grid fabric and/or outside of the grid fabric (i.e., outside of the data center). For example, a computer user may access a web server in the grid fabric through a web page in order to request the average rainfall in a certain location. As part of responding to the request, the web server may query a database server. The database server sends the answer to the query to the web server that forwards the answer to the computer user.

Typically, millions of requests are processed daily by the grid fabric. Accordingly, the grid fabric may encompass hundreds to thousands of nodes. Thus, the grid fabric must be managed and maintained. Specifically, maintenance and management ensures that the grid fabric is functioning properly and is updated. For example, the grid fabric must be monitored for possible failures, modified according to usage, updated as new applications and technologies are added, and scheduled to report usage and failures.

Managing and maintaining the grid fabric is typically performed using multiple heterogeneous management solutions. Specifically, different management solution vendors have products for each of the different types of hardware and software that is used in the grid fabric. For example, one management solution manages the operating system of each of the nodes while another management solution performs change management to determine whether changes are needed to add or remove nodes from the grid fabric while another management solution performs the provisioning of both operating systems and applications on the new nodes.

In the typical configuration, each management solution communicates directly with the nodes the management solution is managing. Accordingly, each management solution is aware of the nodes on the grid fabric and collects data directly from the nodes. Thus, an administrator using the management solutions performs the functions of collating the information retrieved from the management solutions and determining how to update and manage the grid fabric.

### SUMMARY

In general, in one aspect, the invention relates to a method for management of a grid fabric that includes receiving a management request using a protocol, decoupling the management request from the protocol to obtain a decoupled management request, selecting a grid control service from a plurality of grid control services configured to perform the decoupled management request, identifying at least one node in the grid fabric associated with the decoupled management request by the grid control service, executing at least one command based on the decoupled management request using the at least one node and the grid control service, wherein the at least one command generates a result, and outputting the result.

In general, in one aspect, the invention relates to a system for gathering management data from a grid fabric comprising a transport binder configured to receive a management request using a protocol; and decouple the management request from the protocol to obtain a decoupled management request. Further, the system includes a grid control service of a plurality of grid control services configured to identify at least one node in the grid fabric associated with the decoupled management request, execute at least one command based on the decoupled management request using the at least one node, wherein the at least one command generates a result, and output the result. In addition, the system includes a grid management bus connected to the transport binder and configured to select the grid control service from the plurality of grid control services configured to perform the decoupled management request.

In general, in one aspect, the invention relates to a computer usable medium having computer readable program code embodied therein for executing a method for managing a grid fabric that includes receiving a management request using a protocol, decoupling the management request from the protocol to obtain a decoupled management request, and selecting a grid control service from a plurality of grid control services configured to perform the decoupled management request, wherein the grid control service identifies at least one node in the grid fabric associated with the decoupled management request, and wherein the at least one node executes at least one command based on the decoupled management request to output a result

Other aspects and advantages of the invention will be apparent from the following description and the appended claims.

### BRIEF DESCRIPTION OF DRAWINGS

FIG. 1 shows a schematic diagram of a system for grid management in accordance with one or more embodiments of the invention.

FIG. 2A-2B shows a flowchart of a method for managing a grid fabric in accordance with one or more embodiments of the invention.

FIG. 3 shows a computer system in accordance with one embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and apparatus for grid management. Specifically, embodiments of the invention provide a mechanism for separating management of the services and applications executing on the grid fabric with management of individual nodes in the grid fabric. More specifically, rather than directly accessing the nodes for gathering management data, services may simply send a request to the grid level management using virtually any protocol. In one or more embodiments of the invention, the protocol is removed from the request and transmitted to a grid manager (described below) that has the ability to access individual nodes on the grid fabric.

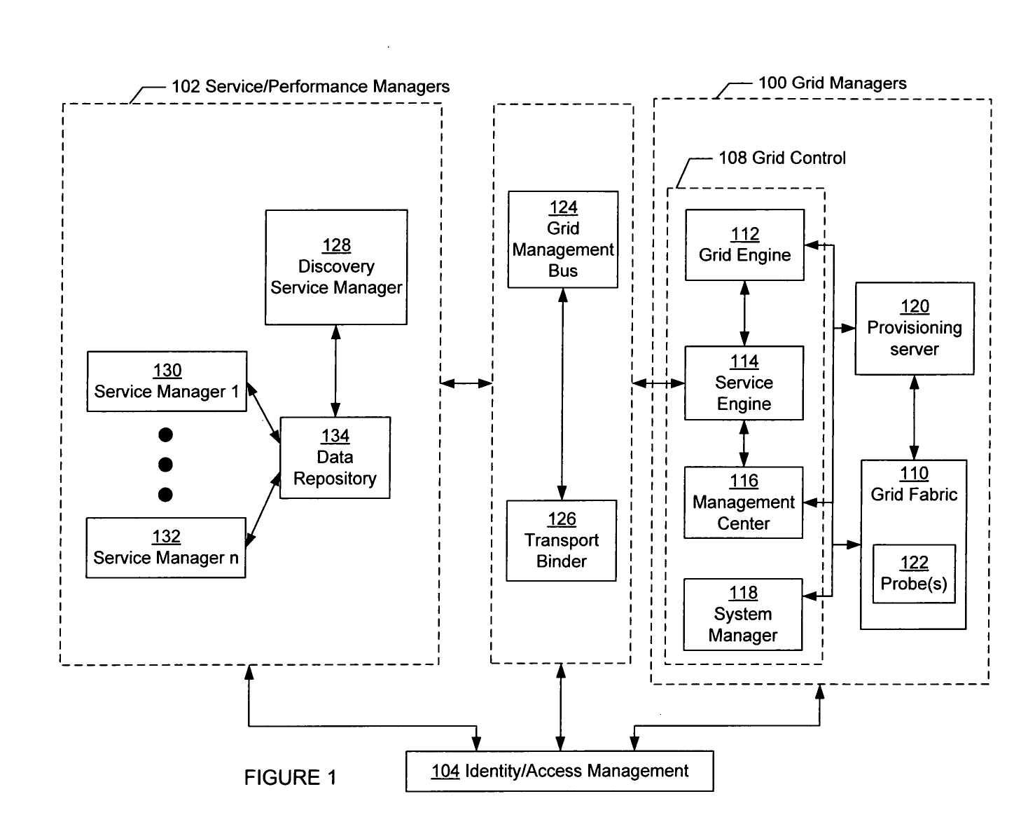

FIG. 1 shows a schematic diagram of a system for grid management in accordance with one or more embodiments of the invention. As shown in FIG. 1, the system includes grid managers (100), service and performance managers (102), and identity and access management (104). Each of these components is described below.

In the system shown, the grid managers (100) include the grid fabric (110) and grid control (108). Typically, the grid managers also include a separate provisioning server (120). Each of these components is described below.

The grid fabric (110) corresponds to a group of nodes (e.g., web servers, database servers, farm servers, personal computers, handheld devices, and other such computing devices) and the connection (e.g., wires, circuit boards, wireless signals, routers, switches, etc.) between the nodes.

The nodes within the grid fabric (110) are heterogeneous in accordance with one or more embodiments of the invention. Specifically, applications such as the operating system, hardware, and/or desired functionality performed may vary across the grid fabric. For example, certain nodes may use a different operating system from other nodes in the grid fabric. While the nodes may be heterogeneous, those skilled in the art will appreciate that groups of nodes are homogeneous. Specifically, multiple nodes may exist with the same applications, hardware, and/or desired functionality.

In one or more embodiments of the invention, the grid fabric (110) includes probes (122). A probe (122) corresponds to a logical block, hardware or software, that can obtain performance information about the grid fabric. Specifically, each node in the grid fabric typically includes multiple probes, each with a specific functionality. Further, the probes, in one or more embodiments of the invention, are lightweight. Therefore, the probes do not heavily degenerate performance when executing. For example, a probe (122) may correspond to a small block of software code that gathers performance information, such as a Dtrace probe, developed by Sun Microsystems™, Inc. (located in Santa Clara, Calif.). Those skilled in the art will appreciate that multiple variations of probes exist that may also be used.

Further, each probe may be used to gather different types of data. For example, some probes may include functionality to gather network bandwidth data, while other probes may include functionality to gather data specific to a single application.

Associated with each probe is a state of the probe. Specifically, the probe may be in an execution state or in a sleep state. While in the execution state, the probe monitors the execution of a node. While in the sleep state, the probe does not execute or monitor the node.

Continuing with FIG. 1, the grid managers (100) include a provisioning server (120). The provisioning server (120) corresponds to at least one server that includes a copy of at least one application that is provisioned or to be provisioned on the grid fabric (110). Specifically, the provisioning server (120) includes functionality to transfer a copy of the application onto one or more nodes on the grid fabric (110).

The grid managers (100) additionally include grid control (108). The grid control (108) includes one or more grid control services (e.g., grid engine (112), service engine (114), management center (116), system manager (118)). In one or more embodiments of the invention, the grid control services (e.g., grid engine (112), service engine (114), management center (116), system manager (118)) include functionality to communicate with individual nodes in the grid fabric (110). Specifically, the grid control services may not only be aware of each node, but also the particular hardware and software of all nodes, or a portion thereof. Each of the aforementioned grid control services (e.g., grid engine (112), service engine (114), management center (116), system manager (118)) is described below.

A grid engine (112) corresponds to a grid control service that includes functionality to schedule jobs on the grid fabric (110). A job (not shown) corresponds to a group of related instructions or commands that are to be executed by one or more node(s). For example, a job (not shown) may correspond to a request from a user for executing an application, a request for service from an application, etc. In one or more embodiments of the invention, the grid engine includes functionality to obtain performance information of node(s) in the grid fabric (110) and schedule jobs based on the performance information.

Additionally, the grid engine (112) includes functionality to monitor usage of the grid fabric (100). For example, using the usage information, the grid engine (112) may include functionality to manage commercial transactions with a service or customer for the usage of the grid fabric (110).

The grid control (108) may also include a management center (116). The management center (116) corresponds to a grid control service that includes functionality to monitor and manage a particular node's behavior. Specifically, the management center (116) includes functionality to obtain performance information about a node in the grid fabric (110). In one or more embodiments of the invention, the management center (116) includes functionality to modify hardware and/or software configuration in the grid fabric (110).

The grid control (108) may also include a system manager (118). The system manager (118) includes functionality to manage applications on the grid fabric (110). Specifically, the system manager (118) includes functionality to discover, patch, and monitor grid fabric (110) and provision the operating system and applications on the nodes. In one or more embodiments of the invention, the system manager (118) includes functionality to retrieve performance data from the nodes in order to determine nodes on which to provision a new application or move an existing application.

Furthermore, the grid control (108) includes a service engine (114) in accordance with one or more embodiments of the invention. A service engine (114) includes functionality to receive a request and determine the appropriate grid control service for performing and/or managing any operations for the service request.

Those skilled in the art will appreciate that other grid control services may also be used. Further, the functionality provided by the grid control services may be performed by a single module or multiple co-existing modules. Specifically, the functionality provided by the grid control service may be provided by a single application executing on one or more servers or multiple applications executing on one or more servers.

Continuing with FIG. 1, the system also includes a grid management bus (124) and a transport binder (126) that is connected to both the grid managers (100) and the service/performance managers (102). The grid management bus (124) corresponds to an enterprise service bus that includes functionality to send messages asynchronously and synchronously. The grid management bus (124) is both able to manage a large number of messages and transport requests and data between the grid managers (100) and the service and performance managers (102). More specifically, the grid management bus is multi-threaded to provide high throughput and ensure high volume access without crashing any servers. In one or more embodiments of the invention, the grid management bus (124) provides and event driven mechanism whereby events (i.e., requests or information) being sent from the service/performance managers (102) are routed properly to the appropriate grid control (108). Further, the grid management bus (124) ensures performance information is routed back to the service and performance manager (102).

The grid management bus is connected to a transport binder (126). The transport binder (126) includes functionality to decouple a protocol from a request. Specifically, the protocol may correspond to a network and/or data format protocol. Accordingly, the transport binder (126) includes functionality to decouple the protocol from the request and forward the message to the grid managers (100) using a protocol known by the service engine (114). Further, the transport binder (126) may also include functionality to route any results from the grid managers (100) to the service and performance managers (102).

The service and performance managers (102) are connected to the grid management bus (124) and the transport binder (126). The service and performance managers include functionality to monitor the grid fabric as a whole. Specifically, the service and performance managers (102) monitor services and/or applications executing on the grid fabric. More specifically, the service and performance managers (102) include functionality to perform service level management of the grid fabric in accordance with one or more embodiments of the invention. Accordingly, the service and performance managers (102) may not necessarily have full knowledge of or control any particular node on the grid fabric. Rather, the service and performance managers (102) may control a service that spans multiple nodes. Thus, the service and performance managers (102) are pluggable in accordance with one or more embodiments of the invention. Specifically, a service and performance manager may be easily added (or removed) to the service and performance managers without affecting other service and performance managers. In one or more embodiments of the invention, the service and performance managers include a discovery service manager (128), a data repository (134), and a group of pluggable service managers (e.g., service manager 1 (130), service manager n (132)). Each of these components is described below.

The discovery service manager (128) corresponds to a module that includes functionality to learn and manage the configuration and topology of the grid fabric (110). Specifically, the discovery service manager (128) includes functionality to determine both hardware and software configuration of the grid nodes. For example, the discovery service manager (128) includes functionality to determine how each application is configured to operate and how the hardware is configured.

Further, the discovery service manager (128) is configured to learn how the nodes are connected. Specifically, the discovery service manager (128) is able to determine the hardware and software used to connect the nodes. By having a discovery service manager, service managers (e.g., service manager 1 (130), service manager n (132)) are able to share information allowing the grid manager (100) to operate without multiple interruptions for service.

In one or more embodiments of the invention, the discovery service manager (128) is connected to a data repository (134). The data repository (134) corresponds to a centralized storage unit (e.g., a flat file, hierarchal database, file system, disks, or any other storage mechanism) for data and information. Using the data repository (134), data is able to be shared across different service managers (e.g., service manager 1 (130), service manager n (132)). Those skilled in the art will appreciate that multiple techniques exist that do not rely upon a data repository (134). For example, in an alternative embodiment, the services may communicate with each other when information is retrieved or desired.

Continuing with the service and performance managers (102) of FIG. 1, the service and performance managers may also include service managers (e.g., service manager 1 (130), service manager n (132)). In one or more embodiments of the invention, the service managers (e.g., service manager 1 (130), service manager n (132)) are pluggable. Specifically, a service manager (e.g., service manager 1 (130), service manager n (132)) may be added or removed without necessarily affecting the system. Because the service managers are pluggable, one or more service managers may correspond to managers from third party vendors. Accordingly, the system includes functionality to make the indirection of having separate grid managers (100) transparent to a third party service manager.

In one or more embodiments of the invention, the service manager (e.g., service manager 1 (130), service manager n (132)) include a help desk, an asset manager, and a compliance manager. A help desk corresponds to a manager that includes functionality to receive requests for assistance from a user or device. Based on the request, the help desk may obtain information to determine whether an error exists on the grid fabric (110). Specifically, the help desk includes functionality to receive an error from the grid fabric (110) or from a user using resources available at the grid fabric (110). The help desk further includes functionality to send a correction message containing an approved process for corrective action to the user and/or grid fabric (110).

An asset manager includes functionality to track the grid fabric (110) as a resource and maintain configuration meta-data of each node in the grid fabric (110). Further, the asset manager includes functionality to determine whether the grid fabric (110) is functioning properly or whether new nodes need to be added to the grid fabric (110). A compliance manager includes functionality to ensure that the grid fabric (110) and any modifications to the grid fabric (110) are in compliance with the specification and requirements of the grid fabric (110). Specifically, in one or more embodiments of the invention, before modifications are made to any service on the grid fabric (110), the compliance manager includes functionality to ensure that the modifications comply with any requirements of the grid fabric (110).

The service managers (e.g., service manager 1 (130), service manager n (132)) may also include application specific managers. For example, the service managers may include a service manager that only monitors and controls a database application and a separate service manager that monitors and controls a web service application.

Further, in one or more embodiments of the invention, the system also includes identity and access management (104). The identity and access management (104) includes functionality to communicate with a user (not shown) using virtually any device. Specifically, the identity and access manager includes functionality to determine whether a user has any access permissions for performing operations requested by the user. For example, if a user wants to add a service, then the identity and access management (104) includes functionality to determine whether the user is an administrator with access rights to add a service. Further, the identity and access management (104) also includes functionality to communicate with the user using virtually any device and any protocol known in the art.

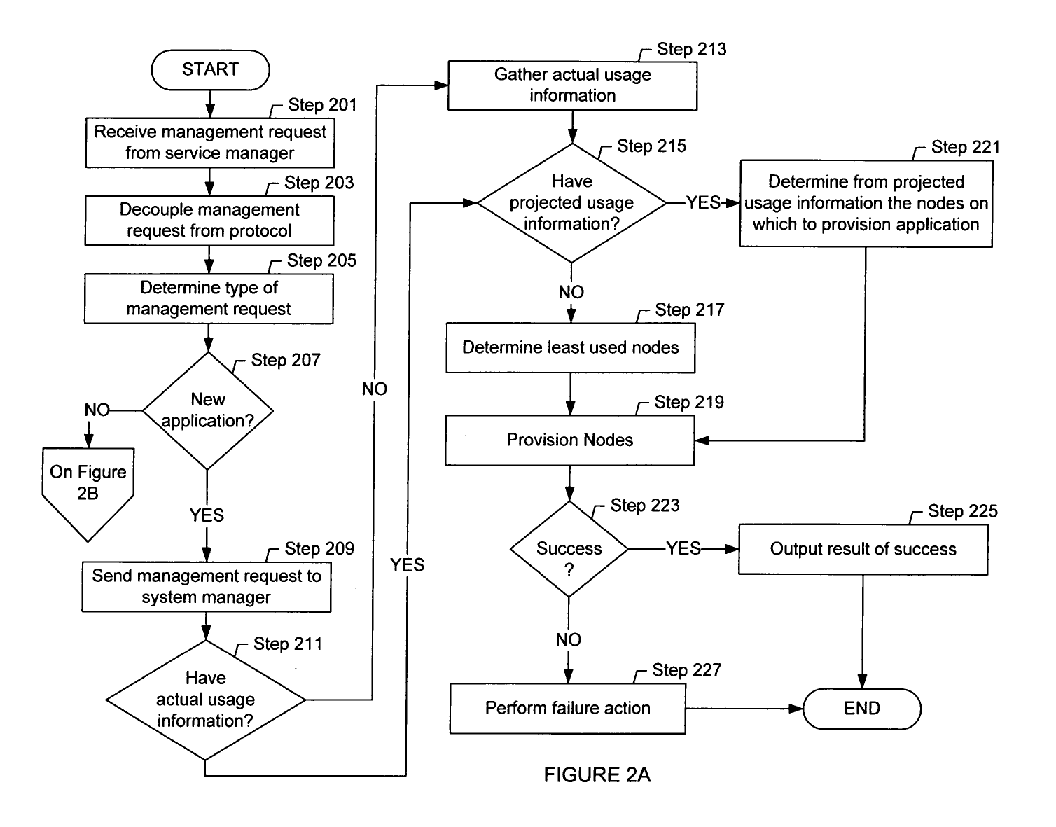

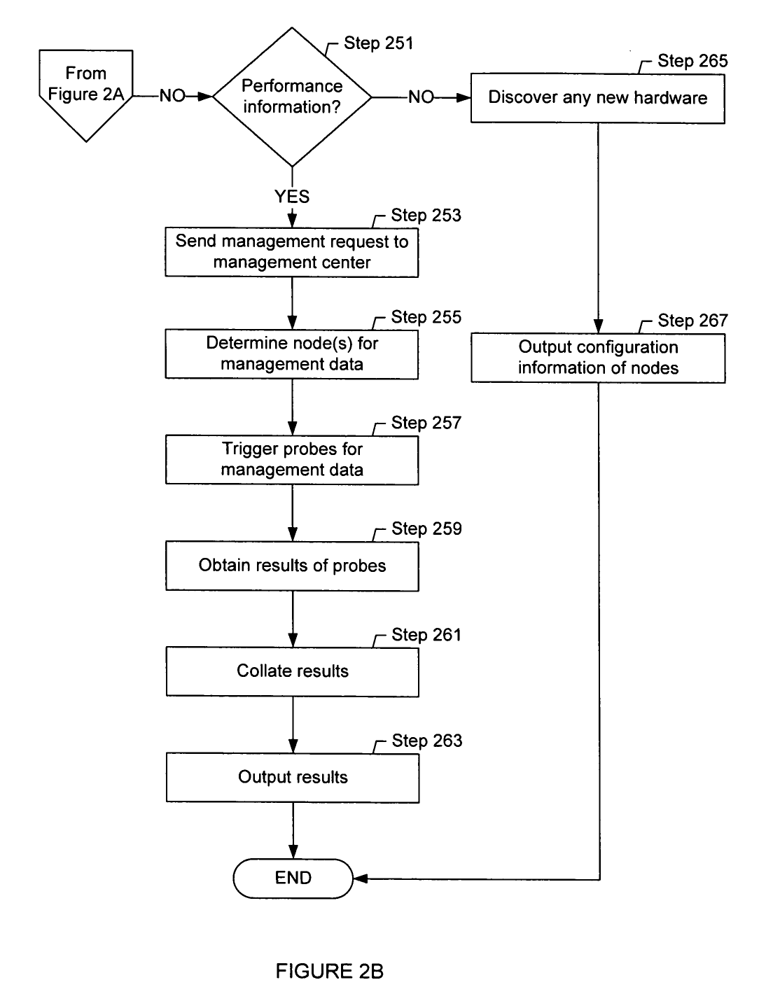

FIG. 2A-2B shows a flowchart of a method for managing a grid fabric in accordance with one or more embodiments of the invention. Specifically, FIGS. 2A and 2B shows a flowchart of a method for receiving requests from a user or service and performance manager. As shown in FIG. 2A, initially a management request is received from a service manager (Step 201). The management request may be received using virtually any protocol known in the art. Further, the management request may be received directly or indirectly from the service manager.

After receiving the management request, the management request is decoupled from the protocol (Step 203). Specifically, in one or more embodiments of the invention, the transport binder removes the protocol used to send the management request and translates the message into a format known by the grid managers, such as web service descriptive language. At this stage, the transport binder may maintain a listing of the protocol used to send the message in order to transmit results using the same or functionally equivalent protocol. The message is then routed to the service engine using the grid management bus.

Next, the type of management request is determined (Step 205). Specifically, a determination is made whether the management request is for provisioning a new application (Step 207). A new application may correspond to an application not yet provisioned on any nodes in the grid fabric or an application that is already provisioned on certain nodes, but not on other nodes. If the management request is for a new application, then the management request is sent to the system manager (Step 209).

Next, a determination is made whether the system manager has management data in the form of actual usage information about the grid fabric (Step 211). For example, the actual usage information may include the number of requests processed by each node, the type of hardware on the node, the configuration profile of the system, etc. If the system manager does not have actual usage information about the grid fabric, then the actual usage information is gathered (Step 213). One mechanism for gathering actual usage information is to trigger (i.e., awaken or execute) probes in the grid fabric. Those skilled in the art will appreciate that only the probes related to the new application may be triggered. For example, if the application is related only to web services, then database related probes may not be triggered. Over a certain time period, the probes generate data. The generated data is then transmitted back, directly or indirectly, to the system manager.

Continuing with FIG. 2A, once the system manager has the actual usage information or if the system manager already has the actual usage information, then a determination is made whether the system manager has projected usage information (Step 215). The system manager may obtain the projected usage information as part of the management request from the service manager. For example, the service manager may include a statement that a high-volume of traffic for the application will occur during a certain time period. Those skilled in the art will appreciate that the system manager may also query the service manager for the projected usage information.

Accordingly, if the system manager has projected usage information, then the system manager determines from the actual usage information and the projected usage information the best nodes upon which to provision the application (Step 221). The best nodes to provision the application may correspond to the best nodes for the application or the best nodes for the grid fabric as a whole. Those skilled in the art will appreciate that multiple optimization techniques well known in the art may be used to determine the best nodes.

Once the best nodes are determined, then the nodes are provisioned (Step 219). Specifically, a copy of the application is installed on the best nodes, if the application is not already installed, and the application is configured for the node and the usage. At this stage, the system manager may orchestrate the provisioning with the provisioning server. Generally, the provisioning server is used when the application is an operating system application, however other uses of the provisioning server may also exist.

Alternatively, if the system manager does not have the projected usage information and does not obtain the projected usage information, then the least used nodes is determined (Step 217). In one or more embodiments of the invention, the least used nodes correspond to the nodes which have the most resources available. Those skilled in the art will appreciate that various optimization algorithms well known in the art may be used to determine the best nodes for provisioning the application that are least used. Accordingly, once the least used nodes are determined, then the least used nodes are provisioned (Step 219). Those skilled in the art will appreciate that provisioning a node typically requires executing at least one command on the node.

After performing provisioning of the nodes, a determination is made whether the provisioning is successful (Step 223). Specifically, in one or more embodiments of the invention, the application is tested on each node the application is provisioned. If the provisioning is successful and the application is executing properly, then results showing a successful provisioning are outputted (Step 225). Specifically, in one or more embodiments of the invention, a success message is sent back to the service manager using the grid management bus and the transport binder.

Alternatively, if the provisioning is not successful, then a failure action is performed (Step 227). The failure action may include returning to the service manager an indication of the failure or checking the node for determining why failure existed. Accordingly, another attempt could be performed for provisioning the application on at least one node in the grid fabric.

Continuing with Step 207 of FIG. 2A, if a determination is made that the type of management request is not for a new application, than the method continues with FIG. 2B. As shown in FIG. 2B, if the type of management request is not for a new application, then a determination is made whether the management request is for performance information (Step 251). Specifically, a service manager may desire to determine whether the system is functioning properly or whether the performance may be improved. Accordingly, the management request is sent to the management center (Step 253).

Next, the node(s) for gathering the management data is determined (Step 255). Determining which node(s) should be used is generally based on the type of management data that is requested. For example, the service manager may desire to know whether a particular type of hardware has decreased throughput at a certain time. Accordingly, nodes matching the type of hardware are determined to be used to gather the management data. As another example, a service manager may desire to know how a particular application is executing or the actual usage information of an application or service. Accordingly, the management center may perform a look up in a table or other such query device to determine which nodes execute the particular application.

Once the relevant nodes are determined, then the probes for gathering the management data are triggered (Step 257). In one or more embodiments of the invention, only probes related to the management request is triggered. After triggering the probes for the management data, the results are obtained from the probes (Step 259). Specifically, the probes may be configured to output the results in virtually any manner. For example, the probes may be configured to output the result to the file or send the results to the management center.

Once the results are obtained from the probes, then the results are collated (Step 261). At this stage, a statistical analysis may be performed only the results to determine the performance information. As an example, consider the case in which the management request is for performance information for a particular application executing at a particular time. Then in the example, for multiple days the probes related to the application on multiple nodes are generating results. In the example, the results may be collated by the number of queries to the application during the time period for all nodes upon which the application is executing.

Once the results are collated, then the results are outputted (Step 263). Specifically, at this stage, the results are returned to the service manager requesting the performance information. The results may be sent using the grid management bus and the transport binder that returns the result using the protocol that the management request was received.

Alternatively, if the management request is not for performance information, then in one or more embodiments of the invention, the management request is for detecting new hardware. Accordingly, the grid control managers discover any new hardware that may have been added (Step 265). The configuration information of the hardware is then outputted (Step 267). Specifically, the configuration information sent back to the system manager or to the data repository.

Those skilled in the art will appreciate that multiple types of management requests exist that are not explicitly discussed above. For example, applications may be removed, applications and/or nodes may be halted, checkpoints may be performed, etc. Accordingly, the aforementioned management requests are only intended as an example of the multitude of possible management requests that may be performed using embodiments of the invention.

In the following example, consider the case in which a company has a web application that the company projects will receive five million queries between 7:00 AM and 10:00 AM and will receive few queries at any other time. Accordingly, a company requests usage of a data center. The data center is to bill the company accordingly to the actual usage.

In the example, an administrator contacts the data center and creates an account. Next, the administrator accesses the service and performance managers through the identity and access management for the data center. The administrator creates a new web application service manager to monitor the web application of the company. The web application service manager sends a management request to the grid managers for provisioning the web application on any nodes that has sufficient resources available to handle five million queries between 7:00 AM and 10:00 AM. The transport binder decouples the request from the protocol that the service manager uses and the grid management bus sends the request to the service engine. Upon receiving the request, the service engine determines that the request is for provisioning a node. Therefore, the service engine transmits the request to the system manager. The system manager triggers the probes to receive data from the probes. While reviewing data from the probes, the system manager identifies the nodes required to handle the five million queries between 7:00 AM and 10:00 AM. Accordingly, the system manager provisions the nodes with the new web application. If the provisioning is successful, then the system manager sends a success message to the web application service manager.

Continuing with the example, over the course of a year, the grid engine is scheduling queries for the new web application. While the grid engine is scheduling the queries, the grid engine is billing the company for the use of the grid fabric. At the end of the year, the company wants to determine whether the projected usage is correct. Accordingly, an administrator of the company logs into the web application service manager using the identity and access management for the data center and sends a request for usage information. The web application service manager sends a management request to the grid manager. In the transportation of the request, the protocol is removed from the management request and sent to the service engine. Because the management request is for performance information, the management request is sent to the management center. The management center triggers probes on the nodes that the web application is provisioned and collects the data from the probes. Once a time period has elapsed, the management center collates the data into performance information and performs a statistical analysis on the performance. If the performance information, for example, shows that only two million queries are received between 7:00 AM and 10:00 AM, then the web application service manager may send a new management request for re-provisioning the nodes based on the updated information.

As shown in the above example, neither the web application service manager nor the administrator needs to have any direct knowledge of the grid fabric. Rather, the web application service manager and the administrator only manage how the web application operates as a whole. Accordingly, the grid managers are able to remove any complication associated with managing individual nodes on the grid fabric away from the web application service manager.

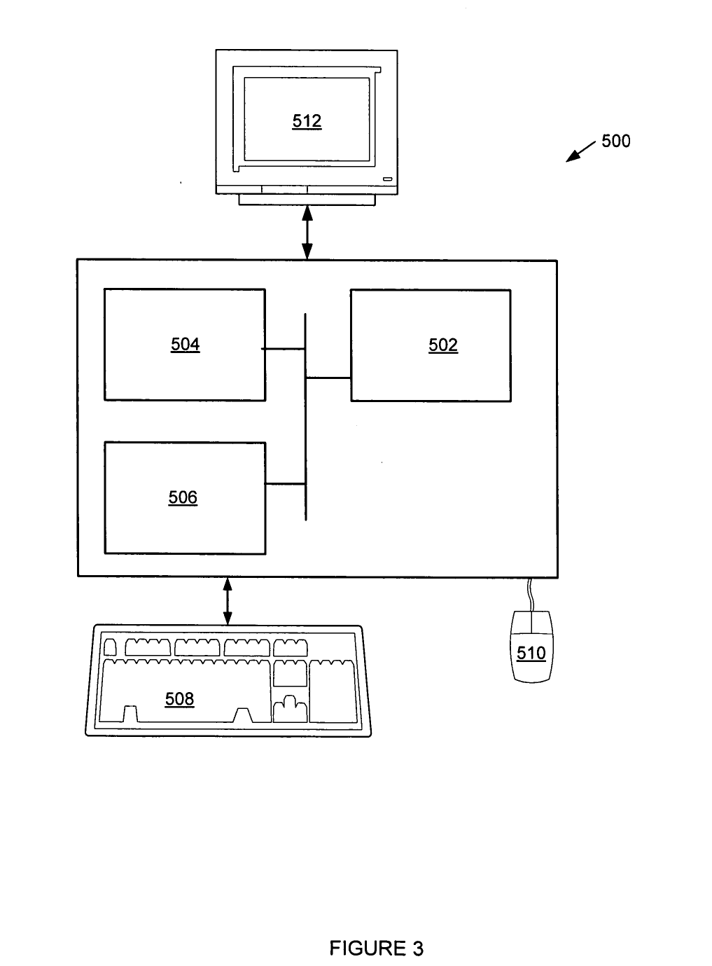

The invention may be implemented on virtually any type of computer regardless of the platform being used. For example, as shown in FIG. 3, a computer system (500) includes a processor (502), associated memory (504), a storage device (506), and numerous other elements and functionalities typical of today's computers (not shown). The computer (500) may also include input means, such as a keyboard (508) and a mouse (510), and output means, such as a monitor (512). The computer system (500) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (500) may be located at a remote location and connected to the other elements over a network. Further, the invention may be implemented on a distributed system having a plurality of nodes, where each portion of the invention (e.g., grid engine, service engine, data repository, management center, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

Embodiments of the invention provide a mechanism for separating the management of individual nodes on the grid fabric with service level management. Accordingly, individual service managers do not need to be aware of how the grid fabric operates. Further, optimization can be performed with respect to the nodes and all applications rather than simply specific applications. More specifically, throughput may be increased for all applications by separating the grid engine and system manager from the service and performance managers.

Furthermore, because the service managers are pluggable, embodiments of the invention are able to support multiple heterogeneous management solutions. More specifically, heterogeneous management solutions may share information using the data repository. Accordingly, management requests are not repeated for the same management data.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for management of a grid fabric comprising:
receiving a management request using a protocol;
decoupling the management request from the protocol to obtain a decoupled management request;
selecting a grid control service from a plurality of grid control services configured to perform the decoupled management request;
identifying at least one node in the grid fabric associated with the decoupled management request by the grid control service;
executing at least one command based on the decoupled management request using the at least one node and the grid control service, wherein the at least one command generates a result; and
outputting the result.

2. The method of claim 1, wherein identifying at least one node comprises:
obtaining management data; and
determining from the management data the at least one node to execute the at least one command.

3. The method of claim 2, wherein the management data comprises performance information, and wherein the performance information is generated by triggering a plurality of probes.

4. The method of claim 2, wherein the management data comprises configuration information, and wherein the configuration information identifies hardware of the at least one node.

5. The method of claim 1, wherein the management request is a request for provisioning an application on the grid fabric.

6. The method of claim 5, wherein the request for provisioning an application comprises the application and a projected usage.

7. The method of claim 5, wherein executing at least one command comprises provisioning the at least one node.

8. The method of claim 1, wherein the management request is a request for performance information.

9. The method of claim 1, wherein a service manager sending the request is pluggable.

10. A system for gathering management data from a grid fabric comprising:
a transport binder configured to:
to receive a management request using a protocol; and
decouple the management request from the protocol to obtain a decoupled management request;
a grid control service of a plurality of grid control services configured to:
identify at least one node in the grid fabric associated with the decoupled management request;
execute at least one command based on the decoupled management request using the at least one node, wherein the at least one command generates a result; and
output the result; and
a grid management bus connected to the transport binder and configured to select the grid control service from the plurality of grid control services configured to perform the decoupled management request.

11. The system of claim 10, wherein identifying at least one node comprises:
obtaining management data; and
determining from the management data the at least one node to execute the at least one command.

12. The system of claim 11, wherein the management data comprises performance information, wherein the performance information is generated by triggering a plurality of probes.

13. The system of claim 11, wherein the management data comprises configuration information, wherein the configuration information identifies hardware of the at least one node.

14. The system of claim 10, wherein the management request is a request for provisioning an application on the grid fabric.

15. The system of claim 14, wherein the request for provisioning an application comprises the application and a projected usage.

16. The system of claim 14, wherein executing at least one command comprises provisioning the at least one node.

17. The system of claim 10, wherein the management request is a request for performance information.

18. The system of claim 10, wherein a service manager sending the request is pluggable.

19. A computer usable medium having computer readable program code embodied therein for executing a method for managing a grid fabric comprising:
receiving a management request using a protocol;
decoupling the management request from the protocol to obtain a decoupled management request; and
selecting a grid control service from a plurality of grid control services configured to perform the decoupled management request,
wherein the grid control service identifies at least one node in the grid fabric associated with the decoupled management request, and wherein the at least one node executes at least one command based on the decoupled management request to output a result.

20. The computer usable medium of claim 19, wherein identifying at least one node comprises:
obtaining management data; and
determining from the management data the at least one node to execute the at least one command.
